(19) United States
(12) Patent Application Publication
(10) Pub. No.: US 2008/0113751 A1
(43) Pub. Date: May 15, 2008

(54) Slot machine and playing method of slot machine

(75) Inventor: Kazumasa Yoshizawa, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Corp., Koto-ku (JP)

(21) Appl. No.: 11/907,163

(22) Filed: Oct. 10, 2007

(30) Foreign Application Priority Data
Oct. 24, 2006 (JP) JP2006-289030

(51) Int. Cl. A63F 13/00

(52) U.S. Cl. 463/20

(57) ABSTRACT

When a base game is executed, symbols arranged on a plurality of defined regions in a matrix state which includes three rows and five columns. When a symbol “JOKER” is statically displayed on a certain defined region in the base game, a game mode is shifted from the base game to a bonus game. When the bonus game is executed, symbols are variably and then statically displayed on a defined region group which includes the certain defined region and defined regions adjacent to the certain defined region.

### CROSS REFERENCE TO RELATED APPLICATION

This application claims benefit of priority under 35 U.S.C. § 119 to Japanese Patent Application No. 2006-289030, filed on Oct. 24, 2006, the entire contents of which are incorporated by reference herein.

### BACKGROUND OF THE INVENTION

1. Field of the Invention

The present invention relates to a slot machine which allows a player to play a game by using one or more game media such as coins and a playing method of the slot machine.

2. Description of the Related Art

In a game arcade in which a conventional slot machine is installed, a player can play a game by inserting into the slot machine one or more game media such as coins or cashes. The slot machine is disclosed in U.S. Pat. No. 6,960,133. The slot machine provides a payout to the player according to a prize generated in a game progress.

Another slot machine is disclosed in Australia Patent No. PQ6296. The another slot machine executes a free game as a sub-game. In the free game, one or more character images overlap with one or more symbols displayed on a display region of a video reel.

The another slot machine provides a new entertainment factor to a player in comparison with the conventional slot machine because it executes the sub-game. However, the another slot machine can not increase a player's expectation for a prize which he/she will obtain in another game (free game) other than a base game.

### SUMMARY OF THE INVENTION

It is an object of the present invention to provide a slot machine capable of increasing a player's expectation for a prize and carrying out an effect display with a more excited entertainment factor and a playing method of the slot machine.

It is a first aspect of the present invention to provide a slot machine comprising: a display that includes a plurality of defined regions in a matrix state which includes one or more rows and one or more columns and rearranges symbols arranged on defined regions; and a controller operable to change the number of defined regions on which symbols are rearranged according to a game mode which includes a base game and a bonus game.

According to the first aspect of the present invention, the slot machine can increase a player's expectation for a prize and carries out an effect display with a more exited entertainment factor because the number of defined regions on which symbols are rearranged is changed according to the game mode.

It is a second aspect of the present invention to provide a slot machine comprising: a display that includes a plurality of defined regions in a matrix state which includes one or more rows and one or more columns and rearranges symbols arranged on defined regions; and a controller operable to variably display symbols on the plurality of defined regions in a base game, shift a game mode from the base game to a bonus game when a certain symbol is statically displayed on a certain defined region in the base game, and variably and then statically display symbols on a defined region group which includes one or more defined regions in the bonus game.

According to the second aspect of the present invention, the slot machine can increase a player's expectation for a prize and carries out an effect display with a more exited entertainment factor because a set of defined regions on which symbols are rearranged in the base game differ from one on which symbols are rearranged in the bonus game.

It is a third aspect of the present invention to provide a slot machine comprising: a display that includes a plurality of defined regions in a matrix state which includes one or more rows and one or more columns and rearranges symbols arranged on defined regions; and a controller operable to variably display symbols on the plurality of defined regions in a base game, shift a game mode from the base game to a bonus game when a certain symbol is statically displayed on a certain defined region in the base game, and variably and then statically displayed symbols on a defined region group which includes the certain defined region and defined regions adjacent to the certain defined region in the bonus game.

According to the third aspect of the present invention, the slot machine can increase a player's expectation for a prize and carries out an effect display with a more exited entertainment factor because symbols are rearranged on the defined region group which includes the certain defined region on which the certain symbol is statically displayed in the base game and defined regions adjacent to the certain defined region in the bonus game.

It is a fourth aspect of the present invention to provide a playing method of a slot machine comprising the step of: changing the number of defined regions on which symbols are rearranged according to a game mode which includes a base game and a bonus game, wherein symbols arranged on a plurality of defined regions in a matrix state which includes one or more rows and one or more columns are rearranged in the base game and the game mode is shifted from the base game to a bonus game.

According to the fourth aspect of the present invention, the playing method can increase a player's expectation for a prize and carries out an effect display with a more exited entertainment factor because the number of defined regions on which symbols are rearranged is changed according to the game mode.

It is a fifth aspect of the present invention to provide a playing method of a slot machine comprising the steps of: executing a base game in which symbols arranged on a plurality of defined regions in a matrix state which includes one or more rows and one or more columns are rearranged; shifting a game mode from the base game to a bonus game when a certain symbol is statically displayed on a certain defined region in the base game; and executing the bonus game in which symbols are variably and then statically displayed on a defined region group which includes one or more defined regions.

According to the fifth aspect of the present invention, the playing method can increase a player's expectation for a prize and carries out an effect display with a more exited entertainment factor because a set of defined regions on which symbols are rearranged in the base game differ from one on which symbols are rearranged in the bonus game.

It is a sixth aspect of the present invention to provide a playing method of a slot machine comprising the steps of: executing a base game in which symbols arranged on a plurality of defined regions in a matrix state which includes one or more rows and one or more columns are rearranged; shifting a game mode from the base game to a bonus game when a certain symbol is statically displayed on a certain defined region in the base game; and executing the bonus game in which symbols are variably and then statically displayed on a defined region group which includes the certain defined region and defined regions adjacent to the certain defined region in the bonus game.

According to the sixth aspect of the present invention, the playing method can increase a player's expectation for a prize and carries out an effect display with a more exited entertainment factor because symbols are rearranged on the defined region group which includes the certain defined region on which the certain symbol is statically displayed in the base game and defined regions adjacent to the certain defined region in the bonus game.

### BRIEF DESCRIPTION OF THE DRAWINGS

FIG. 1 is an explanatory view of a display when a bonus game is executed by a slot machine according to an exemplary embodiment of the present invention.

FIG. 2 is a flowchart of a schematic procedure of a playing method of the slot machine according the exemplary embodiment of the present invention.

FIG. 3 is a perspective view of the slot machine according to the exemplary embodiment of the present invention.

FIG. 4 is an explanatory view of symbols to be displayed on a liquid crystal display of the slot machine according to the exemplary embodiment of the present invention.

FIG. 5 is an explanatory view of a random number table for base game used in a base game executed by the slot machine according to the exemplary embodiment of the present invention.

FIG. 6 is an explanatory view of a random number table for bonus game used in the bonus game executed by the slot machine according to the exemplary embodiment of the present invention.

FIG. 7 is an explanatory view of a payout table used at a time of determining the amount of payout in the base game executed by the slot machine according to the exemplary embodiment of the present invention.

FIG. 8 is an explanatory view of a payout table used at a time of determining the amount of payout in the bonus game executed by the slot machine according to the exemplary embodiment of the present invention.

FIG. 9 is a block diagram of a control circuit of the slot machine according to the exemplary embodiment of the present invention.

FIG. 10 is a flowchart of a game execution process carried out by the slot machine according to the exemplary embodiment of the present invention.

FIG. 11 is a flowchart of a symbol determination process in the game execution process of FIG. 10.

FIG. 12 is a flowchart of a bonus game process carried out by the slot machine according to the exemplary embodiment of the present invention.

FIG. 13 is an explanatory view of a display of the slot machine according to the exemplary embodiment of the present invention.

FIG. 14 is an explanatory view of defined regions of the slot machine according to the exemplary embodiment of the present invention.

FIG. 15 is an explanatory view of a random number table used at a time of determining the execution number of bonus game to be executed by the slot machine according to the exemplary embodiment of the present invention.

### DESCRIPTION OF THE PREFERRED EMBODIMENTS

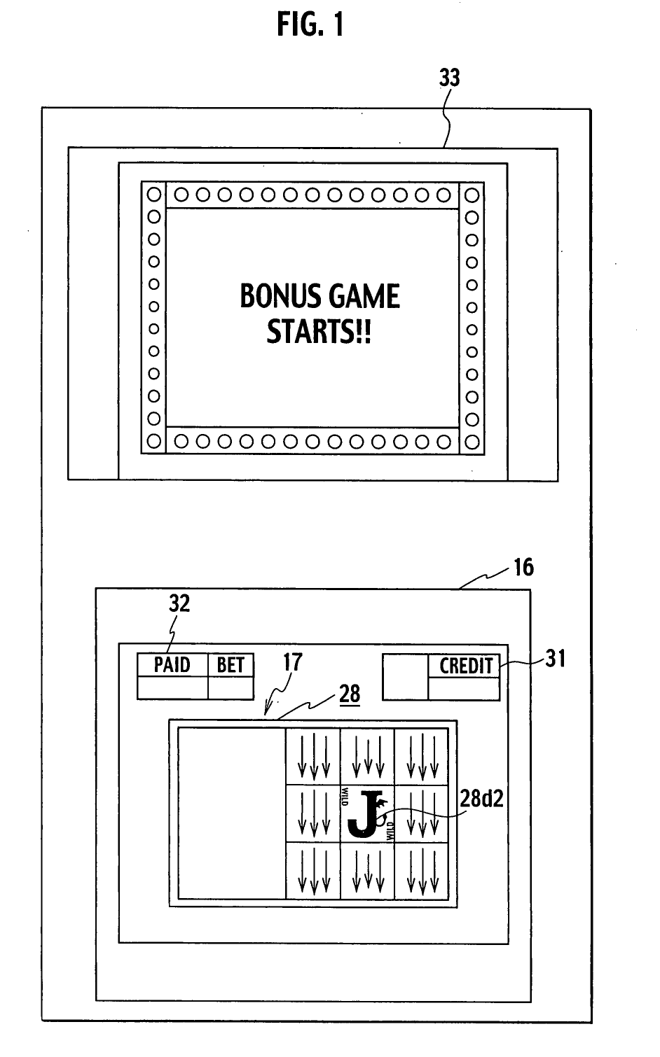

With reference to FIGS. 1 to 15, an exemplary embodiment of the present invention will be described below.

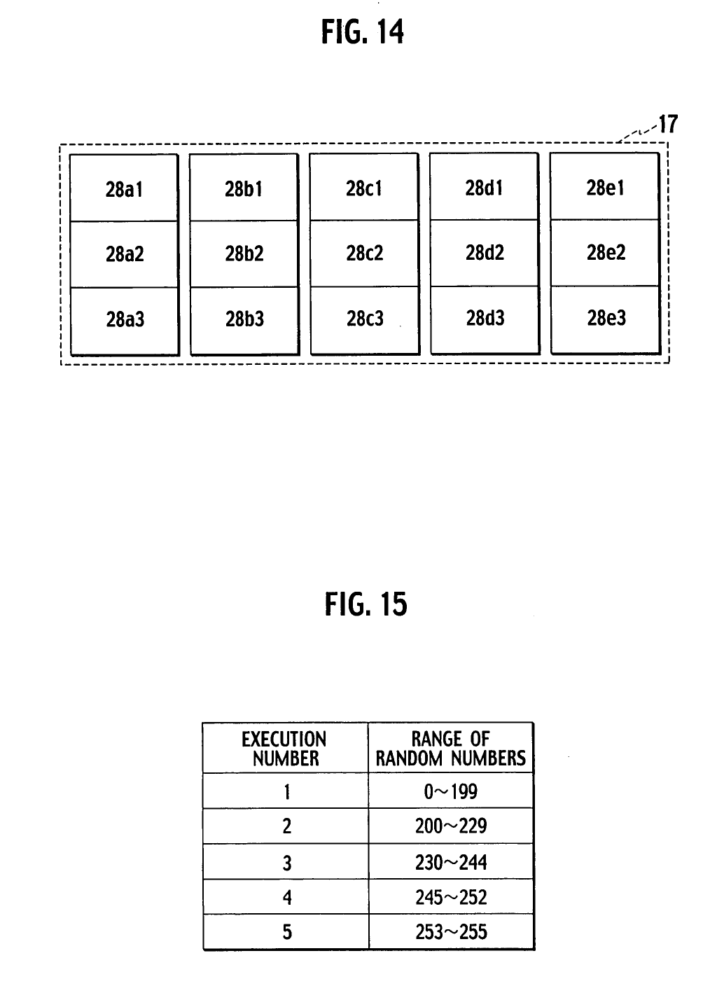

As shown in FIG. 14, defined regions 28a1 to 28e3 are defined on a liquid crystal display (display) 17 in a matrix state which includes three rows and five columns. After a plurality of symbols are variably displayed on the defined regions 28a1 to 28e3, a slot machine 10 changes a game mode from a base game to a bonus game when a symbol “JOKER” is statically displayed (rearranged) on a certain defined region (e.g. a defined region 28d2) (see FIG. 1). In the bonus game, a plurality of symbols are variably displayed and then statically displayed on a defined region group that includes the certain defined region on which the symbol “JOKER” is rearranged and defined regions which are adjacent to the certain defined region.

Therefore, the slot machine 10 can provide to a player an expectation as to whether or not the symbol “JOKER” is statically displayed on the certain defined region (e.g. a defined region 28b2 or the defined region 28d2) in the base game. Further, the slot machine 10 can provide to a player an expectation as to whether or not a certain symbol combination which provides a payout is statically displayed on the defined region group in the bonus game. As a result, the slot machine 10 allows the player's expectation to continue even if the game mode is changed from the base game to the bonus game.

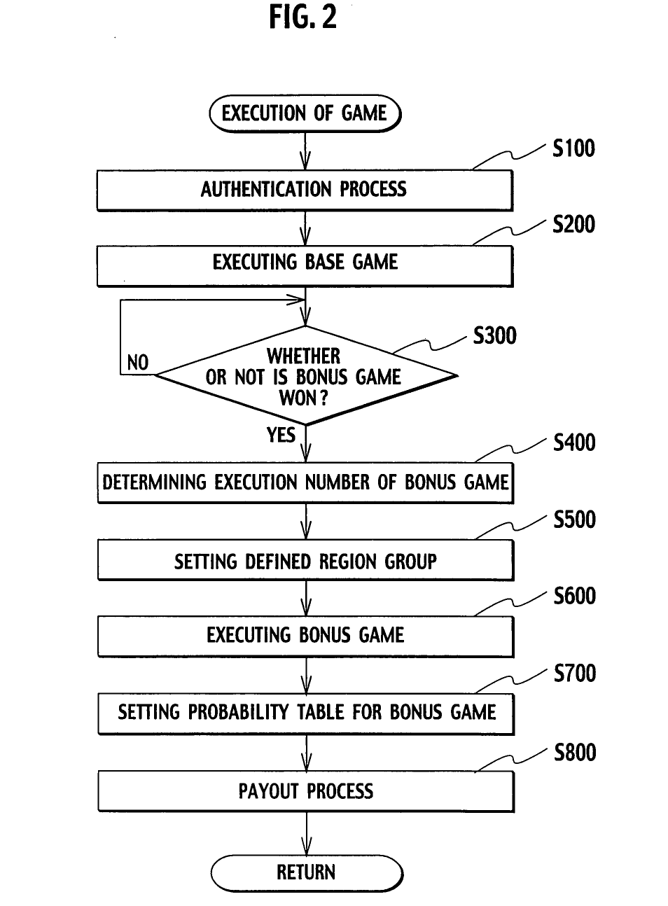

As shown in FIG. 2, the slot machine 10 carries out an authentication process when powered on to be activated (step S100). In the authentication process, the slot machine 10 initially checks whether or not programs for operating the slot machine 10 is normally activated and/or whether and/or not the programs are tampered.

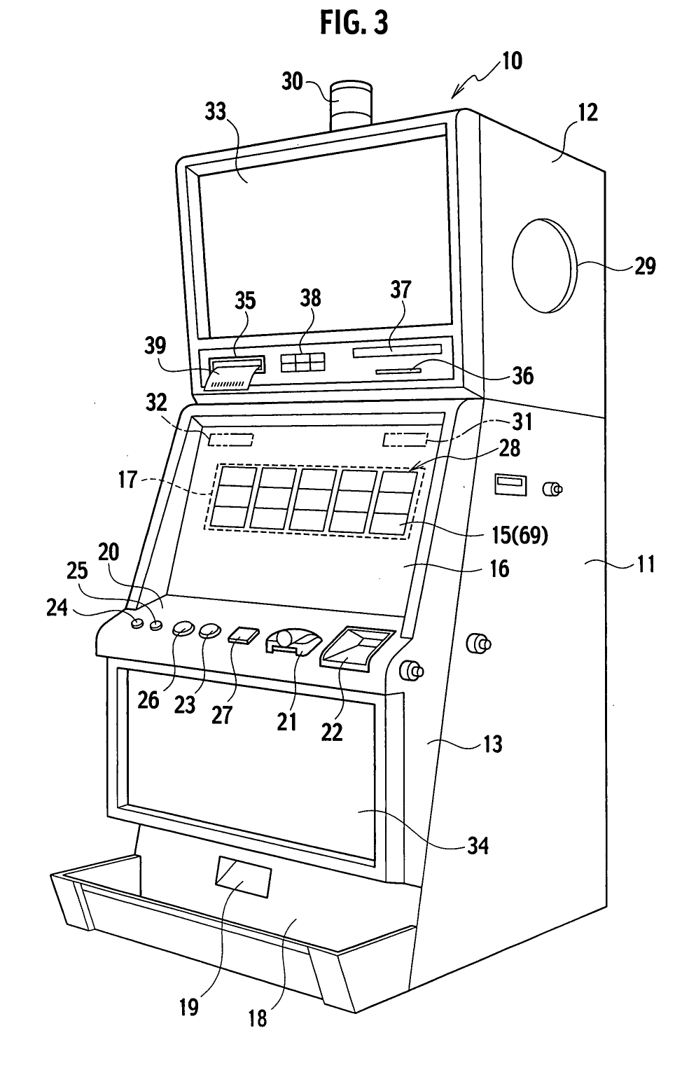

Next, the slot machine 10 executes the base game (step S200). In the base game, when a player inserts one or more coins into a coin receiving slot 21 to bet a desired credit number on a current game and then presses a spin button 23, the plurality of symbols are variably displayed (scrolled) on the defined regions 28a1 to 28e3 formed in a display window 15 mounted on a front surface of a cabinet 11 (see FIG. 3). Then, the plurality of symbols are statically displayed (rearranged) on the defined regions 28a1 to 28e3. It is noted that suffixes “a to e” and “1 to 3” attached to the reference number “28” respectively show columns and rows of the defined region 28.

A touch panel 69 is mounted on a front side of the display window 15. The touch panel 69 is partitioned in the matrix state which includes three rows and five columns, according to the defined regions 28a1 to 28e3. When a player touches one of the defined regions 28a1 to 28e3 in a state where the touch panel 69 is activated, the slot machine 10 identifies the touched defined region.

Next, the slot machine 10 determines whether or not the bonus game is won (step S300). When a certain symbol is rearranged on the certain defined region among the defined regions 28a1 to 28e3 in the base game, the slot machine 10 changes the game mode from the base game to the bonus game. In this embodiment, when the symbol “JOKER” serving as a bonus trigger is statically displayed on the certain defined region, the game mode is changed from the base game to the bonus game. The slot machine 10 executes the bonus game in which symbols are variably displayed and rearranged on the defined region group.

When the bonus trigger is established, the slot machine 10 determines the execution number of bonus game before starting to execute the bonus game (step S400).

Next, the slot machine 10 sets the defined region group (step S500). The defined region group includes the certain defined region on which the symbol “JOKER” is rearranged and defined regions which are adjacent to the certain defined region. For example, if we assume that the certain defined region is the defined region 28b2, the defined regions which are adjacent to the certain defined region are the defined regions 28a1, 28a2, 28a3, 28b1, 28b3, 28c1, 28c2 and 28c3.

Next, the slot machine 10 executes the bonus game in which symbols are rearranged on the defined region group, by the determined execution number of bonus game (step S600).

Next, the slot machine 10 sets a probability table for the bonus game (step S700). In the bonus game, a probability for statically displaying a certain symbol combination which provides a payout on the defined region group set in step S500 is higher than one for statically displaying the certain symbol combination on defined regions in the base game. If the certain symbol combination is rearranged on the defined region group, the slot machine 10 determines the payout number.

Finally, the slot machine 10 provides a payout according to the determined payout number (step S800).

Next, with reference to FIG. 3, a configuration of the slot machine 10 will be described below.

The slot machine 10 is installed in a game arcade. In the slot machine 10, a player uses a coin, a bill or electronic valuable information equivalent to the coin or bill as a game medium for playing the base game. It is noted that the game medium is not limited to the above and may be a medal, a token, electronic money or a ticket. The ticket may be a ticket attached with bar codes, which will be described below.

The slot machine 10 has the cabinet 11, a top box 12 mounted on a top surface of the cabinet 11 and a main door 13 mounted on a front surface of the cabinet 11.

An upper image display panel 33 and a lower image display panel 16 are mounted on the top box 12 and an upper stage of the main door 13, respectively. The display window 15 has a rectangle shape and is mounted on a center portion of the lower image display panel 16. The liquid crystal display 17 is mounted at the back of the display window 15. The liquid crystal display 17 is partitioned into the defined regions 28a1 to 28e3 in the matrix state which includes three rows and five columns (see FIG. 14). When the slot machine 10 executes the base game, a player has visual contact with symbols being variably displayed on the defined regions 28a1 to 28e3 through the display window 15.

The touch panel 69 is mounted on the front side of the display window 15. The touch panel 69 is partitioned in the matrix state which includes three rows and five columns, according to the defined regions 28a1 to 28e3. When a player touches one of the defined regions 28a1 to 28e3 in a state where the touch panel 69 is activated, the slot machine 10 identifies the touched defined region.

It is noted that the matrix state is not limited to three rows and five columns. It is also noted that symbols may be variably displayed by a mechanical reel instead of the liquid crystal display 17. In this case, the mechanical reel functions as the display.

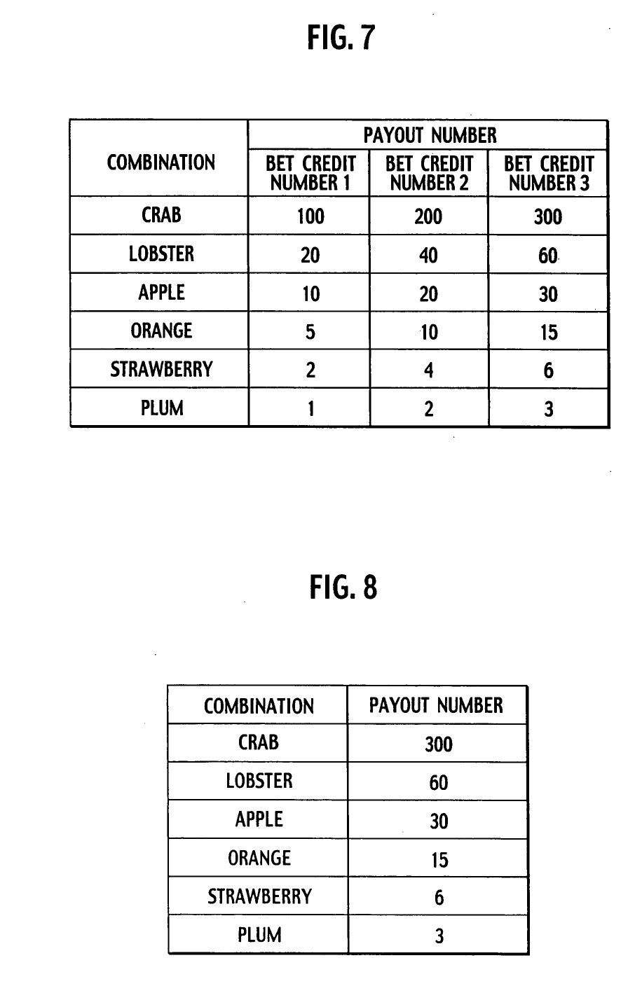

The lower image display panel 16 is provided with a transparent liquid crystal panel and displays various pieces of information on a game and various effect images thereon during the game. The lower image display panel 16 includes a number-of-credits display portion 31 and a number-of-payouts display portion 32. The number-of-credits display portion 31 is a portion where the number of credited coins is displayed as an image. The number-of-payouts display portion 32 is a portion where the number of coins to be paid out by each symbol combination is displayed as an image (see FIG. 7).

A control panel 20, the coin receiving slot 21 and a bill validator 22 are mounted on a lower side of the lower image display panel 16. The coin receiving slot 21 is a slot where one or more coins are received into the cabinet 11. The control panel 20 includes a plurality of buttons (a spin button 23, a change button 24, a cashout button 25, a 1-BET button 26 and a maximum-BET button 27) through which a player inputs instructions related to the process of a game into the slot machine 10.

The spin button 23 is a button for inputting an instruction to start scrolling symbols displayed on the defined regions 28a1 to 28e3. The change button 24 is a button for requesting an exchange of money to a clerk in the game arcade. The cashout button 25 is a button for inputting an instruction to pay out the credited coins to a coin tray 18.

The 1-BET button 26 is a button for inputting an instruction to bet one coin on a current game from among the credited coins. The maximum-BET button 27 is a button for inputting an instruction to bet the maximum number (for example, 3) of coins allowed to be bet on a current game.

The bill validator 22 identifies whether or not a bill is real and takes only real one into the cabinet 11. The bill validator 22 may be configured to read a ticket attached with bar code 39 which will be described below. On a lower front side of the main door 13, that is a lower side of the control panel 20, is provided a belly glass 34 on which a character of the slot machine 10 and so on are drawn.

On a side surface of the top box 12 is provided a speaker 29 for outputting sounds. On the front side of the top box 12 is provided the upper image display panel 33 which has a graphic board 68 on which, for example, effect images, or images for introducing the contents of a game or explaining the rule of a game are displayed. Under the upper image display panel 33 are provided a ticket printer 35, a card reader 36, a data display device 37 and a keypad 38. The ticket printer 35 prints a barcode on a ticket, which includes coded data regarding the number of credits, date, an identification number of the slot machine 10 and so on, and outputs as a ticket attached with bar code 39. With this ticket attached with bar code 39, a player can play a game on another slot machine or exchange to bills or the like at a cashier in the game arcade.

The card reader 36 reads out data from a smart card and writes data into the smart card. The smart card is possessed by a player, on which data for identifying the player and regarding a history of games played by the player is stored.

The data display device 37 is composed of a fluorescent display, and displays, for example, data read by the card reader 36 or data input by a player through the keypad 38. The keypad 38 is used for inputting an instruction regarding the issue of a ticket or data.

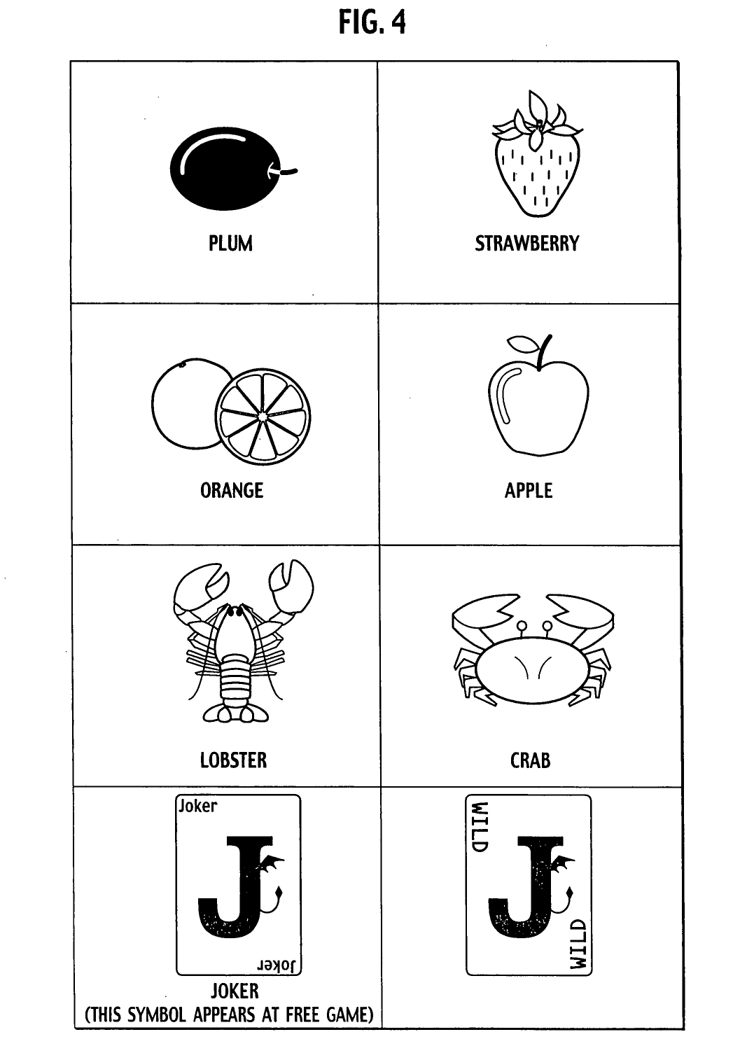

As shown in FIG. 4, symbols “PLUM”, “ORANGE”, “STRAWBERRY”, “APPLE”, “LOBSTER” and “CRAB” are variably displayed on the defined regions 28a1 to 28e3 of the liquid crystal display 17. As we will be described later, when the bonus trigger is established and then the slot machine 10 executes the bonus game, a symbol “JOKER” is variably displayed in addition to the above symbols. A symbol “WILDJOKER” is a wild symbol which functions as the symbols “PLUM”, “ORANGE”, “STRAWBERRY”, “APPLE”, “LOBSTER” or “CRAB”. For example, when the symbol “WILDJOKER” is rearranged between two symbols “ORNAGE”, the slot machine 10 interprets this arrangement as meaning that three symbols “ORNAGE” are arranged. Also, when the symbol “JOKER” is rearranged on a certain defined region, it is changed into the symbol “WILDJOKER” on a defined region group which includes the certain defined region in the following bonus game.

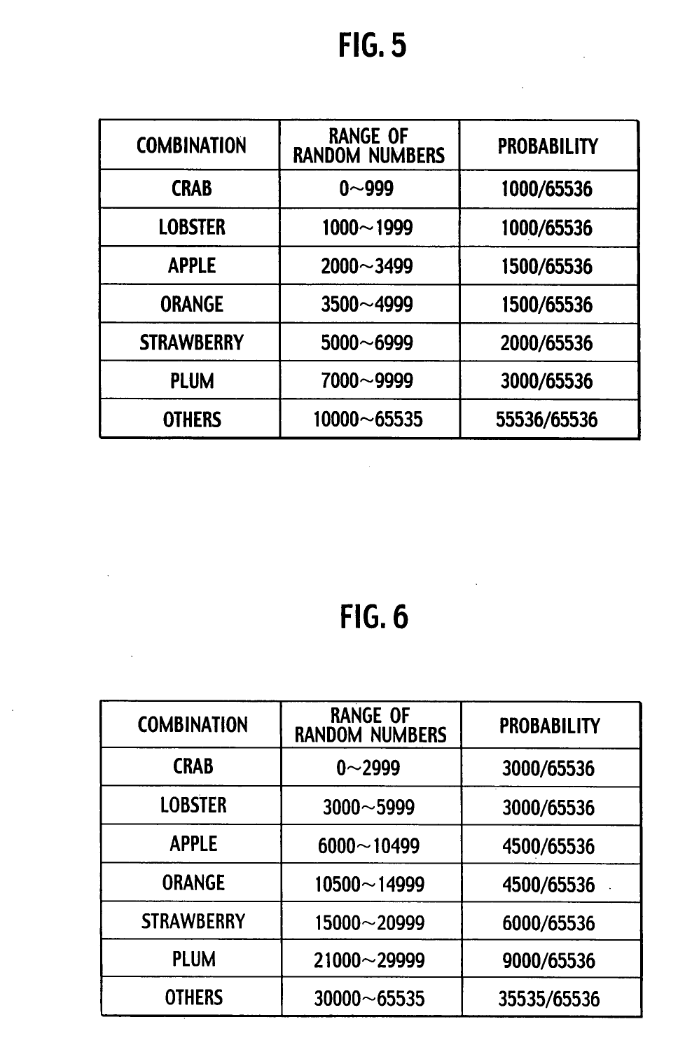

In a random number table for base game shown in FIG. 5, a range of random numbers and a probability are associated to each combination which provides a prize. For example, when one of random numbers “0” to “999” is selected from among random numbers “0” to “65535”, the slot machine 10 internally determines that a symbol combination of “CRAB” is to be statically displayed in the base game. A probability in which the symbol combination of “CRAB” is determined is “1000/65536”.

When one of random numbers “2000” to “3499” is selected from among the random numbers “0” to “65535”, the slot machine 10 internally determines that a symbol combination of “APPLE” is to be statically displayed in the base game. A probability in which the symbol combination of “APLLE” is determined is “1500/65536”.

When one of random numbers “10000” to “65535” is selected from among the random numbers “0” to “65535”, the slot machine 10 internally determines that no symbol combination is to be statically displayed in the base game. A probability in which no symbol combination is determined is “55536/65536”.

In a random number table for bonus game shown in FIG. 6, a range of random numbers and a probability are associated to each combination which provides a prize. In the random number table for bonus game, the probability in which each symbol combination is determined to be statically displayed on the set defined region group is higher than that in the random number table for base game. For example, when one of random numbers “0” to “2999” is selected from among random numbers “0” to “65535”, the slot machine 10 internally determines that a symbol combination of “CRAB” is to be statically displayed in the bonus game. A probability in which the symbol combination of “CRAB” is determined is “3000/65536”.

When one of random numbers “6000” to “10499” is selected from among the random numbers “0” to “65535”, the slot machine 10 internally determines that a symbol combination of “APPLE” is to be statically displayed in the bonus game. A probability in which the symbol combination of “APLLE” is determined is “4500/65536”.

When one of random numbers “30000” to “65535” is selected from among the random numbers “0” to “65535”, the slot machine 10 internally determines that no symbol combination is to be statically displayed in the bonus game. A probability in which no symbol combination is determined is “35536/65536”.

In a payout table for base game shown in FIG. 7, the number of coins to be paid out is associated to each combination which provides a prize and each credit number which is bet on a current game. For example, when a symbol combination of “APPLE” is established in the base game, the slot machine 10 pays out 10 coins if a BET credit number is one, pays out 20 coins if the BET credit number is two or pays out 30 coins if the BET credit number is three. When a symbol combination of “CRAB” is established in the base game, the slot machine 10 pays out 100 coins if the BET credit number is one, pays out 200 coins if the BET credit number is two or pays out 300 coins if the BET credit number is three.

In a payout table for bonus game shown in FIG. 8, the number of coins to be paid out is associated to each combination which provides a prize. For example, when a symbol combination of “APLLE” is established in the bonus game, the slot machine 10 pays out 30 coins. When a symbol combination of “CRAB” is established in the bonus game, the slot machine 10 pays out 300 coins.

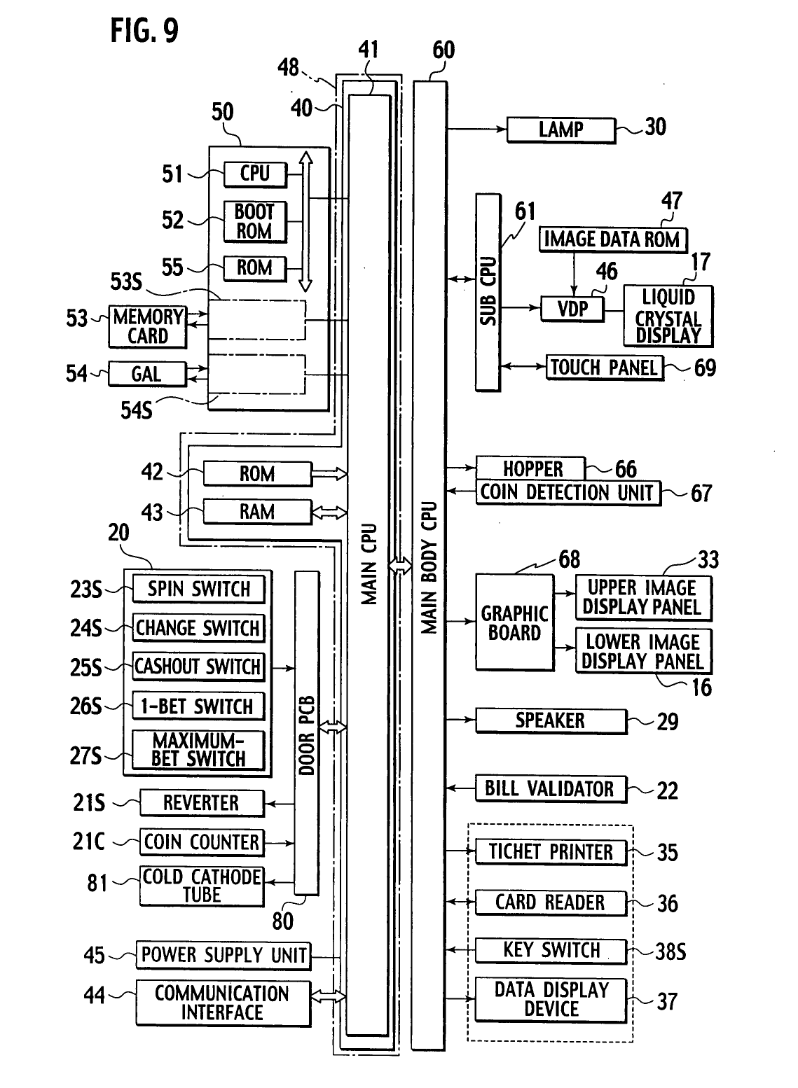

Next, with reference to FIG. 9, an inner configuration of the slot machine 10 shown in FIG. 3 will be described below.

A control circuit of the slot machine 10 comprises a controller 48, a main body printed circuit board (main body PCB) 60, a sub central processing unit (sub CPU) 61, a door printed circuit board (door PCB) 80, various switches and sensors. The controller 48 is composed of the mother board 40 and the gaming board 50.

The gaming board 50 comprises a central processing unit (CPU) 51, a read only memory (ROM) 55 and a boot read only memory (boot ROM) 52, which are interconnected by an internal bus, a card slot 53S adapted for a memory card 53 and an IC socket 54S adapted for a generic array logic (GAL) 54.

The memory card 53 is composed of a nonvolatile memory and stores a game program therein. The game program includes a symbol determination program for determining code numbers corresponding to symbols to be statically displayed on the defined regions 28a1 to 28e3.

The card slot 53S is configured to be suitable for the insertion and removal of the slot card 53 and connected to the mother board 40 by an IDE bus. Accordingly, it is possible to change the kind or contents of a game to be played on the slot machine 10 by removing the memory card 53 from the card slot 53S, storing another game program in the removed memory card 53, and re-inserting the memory card 53 into the card slot 53S. The game program also includes image data and sound data to be output during the game.

The CPU 51, the ROM 55 and the boot ROM 52 which are interconnected by the internal bus, are connected to the mother board 40 by a PCI bus. The PCI bus transmits signals between the mother board 40 and the gaming board 50 and supplies electric power from the mother board 40 to the gaming board 50.

The mother board 40 is composed of a commercial general-purpose mother board (print wire board on which element parts of a personal computer are mounted) and comprises a main central processing unit (CPU) 41, a read only memory (ROM) 42, a random access memory (RAM) 43 and a communication interface 44.

The ROM 42 is composed of a memory device such as a flash memory and stores a program such as a basic input/output system (BIOS) to be executed by the main CPU 41 and data to be used permanently. When the BIOS is executed, the main CPU 41 carries out an initialization process for each peripheral device and starts a reading process for the game program stored in the memory card 53, through the gaming board 50.

The RAM 43 stores therein data and programs which are used when the main CPU 41 carries out processes. The RAM 43 also stores therein data such as a credit number, a bet number and a payout number in a current game. The RAM 43 may store the game program therein.

The main body PCB 60 and the door PCB 80 are connected to the mother board 40 through universal serial buses (USBs). Further, a power supply unit 45 is connected to the mother board 40.

Instruments and devices, which generate input signals to be input into the main CPU 41, and instruments and devices, which are controlled by control signals to be output from the main CPU 41, are connected to the main body PCB 60 and the door PCB 80. The main CPU 41 executes the game program stored in the RAM 43 based on the input signals input thereto and stores the result of execution in the RAM 43 or transmits the control signals to the instruments and devices.

A lamp 30, the sub CPU 61, a hopper 66, a coin detection unit 67, a graphic board 68, the speaker 29, the bill validator 22, the ticket printer 35, the card reader 36, a key switch 38S and the data display device 37 are connected to the main body PCB 60.

The sub CPU 61 is connected to a video display processor (VDP) 46 and the touch panel 69. The sub CPU 61 reads image data of symbols stored in an image data ROM 47, generates images to be displayed on the defined regions 28a1 to 28e3 of the liquid crystal display 17 and outputs the generated images into the liquid crystal display 17.

The touch panel 69 is mounted on the front side of the display window 15. When a player touches the touch panel 69 in a state where the touch panel 69 is activated, the slot machine 10 identifies the touched position. Namely, when the player touches one region of the touch panel 69 corresponding to one of the defined regions 28a1 to 28e3, the slot machine 10 identifies that he/she selects the one defined region.

The hopper 66 is mounted in the cabinet 11 and pays out a predetermined number of coins from a coin payout opening 19 to the coin tray 18 based on a control signal from the main CPU 41. The coin detection unit 67 is mounted in the coin payout opening 19 and outputs an input signal to the main CPU 41 when the coin detection unit 67 detects the payout of the predetermined number of coins from the coin payout opening 19.

The graphic board 68 controls images to be displayed on the upper and lower image display panels 33 and 16 based on a control signal from the main CPU 41. The number-of-credits display portion 31 of the lower image display panel 16 displays the credit number of coins stored in the RAM 43 thereon. The number-of-payouts display portion 32 of the lower image display panel 16 displays the payout number of coins thereon. When the bonus game is executed, the upper image display panel 33 displays the execution number of bonus game.

The graphic board 68 includes a VDP which generates image data based on a control signal from the main CPU 41 and a video RAM which temporally stores the image data generated by the VDP. Image data to be used by the VDP is included in the game program which is read from the memory card 53 and then stored in the RAM 43.

The bill validator 22 identifies whether or not a bill inserted by a player is real and accepts only real bill. Accepting a real bill, the bill validator 22 outputs an input signal to the main CPU 41 based on the amount of accepted bill. The main CPU 41 stores in the RAM 43 the credit number corresponding to the amount of accepted bill notified by the input signal.

The ticket printer 35 prints on a ticket a barcode in which the credit number stored in the RAM 43 and data such as date and an identification number of the slot machine 10 are coded, based on a control signal from the main CPU 41, and outputs it as the ticket attached with bar code 39. The card reader 36 reads out data stored in the smart card and sends the read data to the main CPU 41, and writes data into the smart card based on a control signal from the main CPU 41. The key switch 38S is mounted on the key pad 38 and outputs an input signal to the main CPU 41 when a player operates the key pad 38. The data display device 37 displays data read out by the card reader 36 or data input by a player with the key pad 38, based on a control signal from the main CPU 41.

The control panel 20, a reverter 21S, a coin counter 21C and a cold cathode tube 81 are connected to the door PCB 80. The control panel 20 includes a spin switch 23S corresponding to the spin button 23, a change switch 24S corresponding to the change button 24, a cashout switch 25S corresponding to the cashout button 25, a 1-BET switch 26S corresponding to the 1-BET button 26 and a maximum-BET switch 27S corresponding to the maximum BET button 27. Each switch outputs an input signal to the main CPU 41 when a player presses a button corresponding to each switch.

The coin counter 21C is mounted in the coin receiving slot 21 and identifies whether or not a coin inserted by a player is real. The coin counter 21C discharges a coin other than the real one. Detecting a real coin, the coin counter 21C outputs an input signal to the main CPU 41.

The reverter 21S which is operated based on a control signal from the main CPU 41 sorts coins identified as real by the coin counter 21C into a cash box (not shown) provided in the slot machine 10 or the hopper 66. When the hopper 66 is already filled with coins, newly identified coins are sorted by the reverter 21S into the cash box. When the hopper 66 is not filled with coins, newly identified coins are sorted into the hopper 66. The cold cathode tube 81 is mounted at back sides of the upper and lower image display panels 33 and 16 and functions as a backlight. The cold cathode tube 81 is turned on based on a control signal from the main CPU 41.

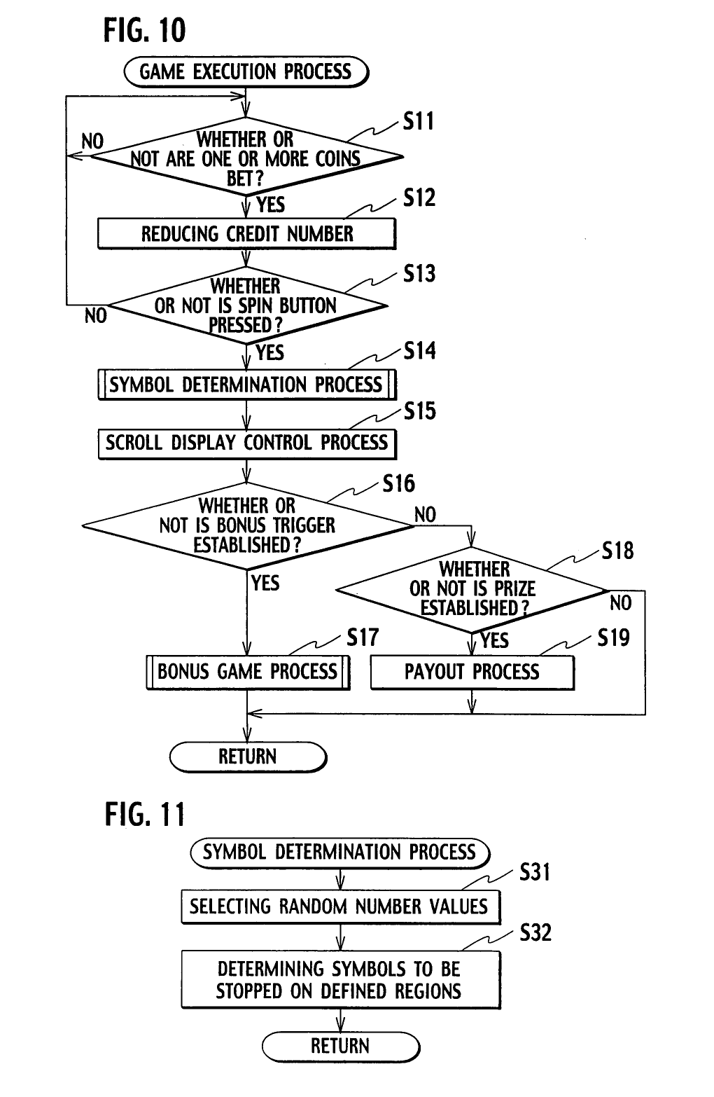

Next, with reference to FIGS. 10 to 12, processes carried out by the slot machine 10 will be described below.

The main CPU 41 reads out the game program to conduct a game. In a game execution process shown in FIG. 10, the main CPU 41 first determines whether or not one or more coins are bet (step S11). More specifically, the main CPU 41 determines whether or not it receives an input signal from the 1-BET switch 26S or the maximum-BET switch 27S. If one or more coins are not bet, the process remains to step S11.

If one or more coins are bet, the main CPU 41 reduces the credit number stored in the RAM 43 according to the number of bet coins (step S12). If the number of bet coins is larger than the credit number stored in the RAM 43, the process returns to step S11 without reducing the credit number. If the number of bet coins is larger than an upper limit value (e.g. three) which a player can bet on one unit game, the process proceeds to step S13 without reducing the credit number.

In step S13, the main CPU 41 determines whether or not the spin button 23 is pressed. More specifically, the main CPU 41 determines whether or not it receives an input signal from the spin switch 23S. If the spin button 23 is not pressed, the process returns to step S11. In this case (e.g. the spin button 23 is not pressed and an instruction for finishing the game is input), the main CPU 41 cancels the reduction result in step S12.

If the spin button 23 is pressed, the main CPU 41 carries out a symbol determination process (step S14). In the symbol determination process, the main CPU 41 executes a symbol determination program stored in the RAM 43 to determine symbols to be rearranged. The symbol determination process will be described later with reference to FIG. 11. In the exemplary embodiment, the main CPU 41 determines symbols to be statically displayed to establish one or more prizes from among plural kinds of prizes. However, the main CPU 41 may establish one or more prizes from among plural kinds of prizes and then determine symbols to be statically displayed according to the established one or more prizes.

In step S15, the main CPU 41 carries out a scroll display control process for the defined regions 28a1 to 28e3 of the liquid crystal display 17. In the scroll display control process, the main CPU 41 statically displays on the defined regions 28a1 to 28e3 symbols which are determined in step S14.

In step S16, the main CPU 41 determines whether or not a bonus trigger is established. More specifically, the main CPU 41 determines whether or not a symbol “JOKER” which functions as the bonus trigger is statically displayed on the defined region 28b2 or 28d2. If the bonus trigger is established, the main CPU 41 reads out a program for executing the bonus game from the RAM 43 to carry out a bonus game process (step S17). Then, the process returns to step S11.

If the bonus trigger is not established, the main CPU 41 determines whether or not a prize is established (step S18). More specifically, the main CPU 41 determines that the number of symbols statically displayed on the defined regions 28a1 to 28e3 or a combination of symbols statically displayed on a payline. For example, when five symbols “ORANGE” is statically displayed on one row in a condition where a player bets one coins, the main CPU 41 pays out five coins based on the random number table for base game.

If the prize is established, the main CPU 41 carries out a payout process (step S19). Then, the process returns to step S11. If the prize is not established, the process returns to step S11.

Next, the symbol determination process to be carried out in step S14 shown in FIG. 10 will be described below, with reference to FIG. 11. The main CPU 41 executes a symbol determination program stored in the RAM 43 to carry out the symbols determination process.

In step S31, the main CPU 41 executes a random number generating program included in the symbol determination program to select one random number corresponding to each defined region from among random numbers “0” to “255”. In the present exemplary embodiment, the one random number is a software random number which is selected on the program. However, the one random number may be a hardware random number which is selected on a random number generator.

In step S32, the main CPU 41 determines one symbol to be statically displayed on each defined region based on the selected one random number.

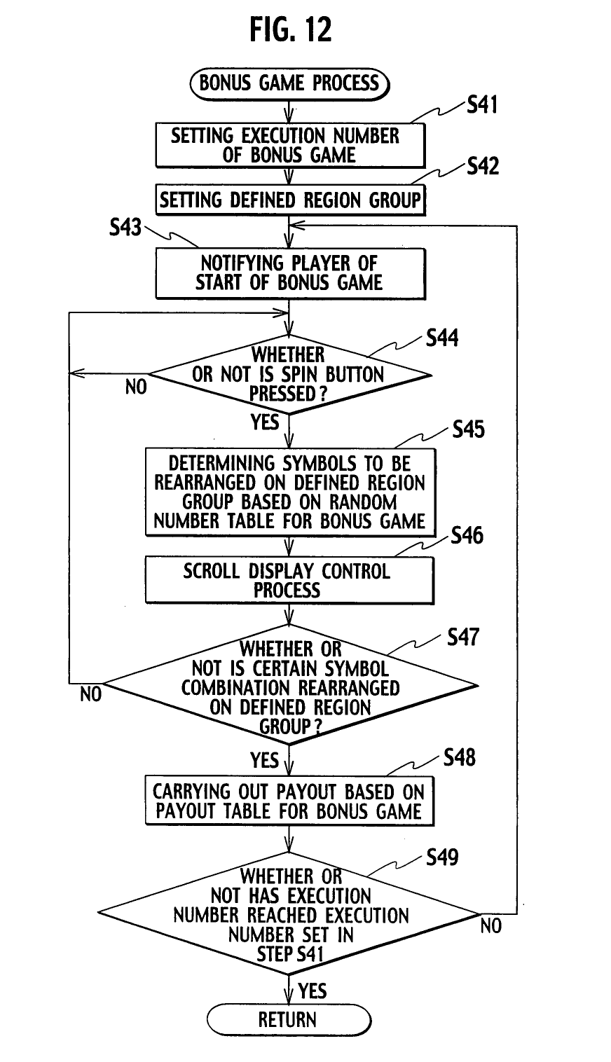

Next, the bonus game process to be carried out in step S17 shown in FIG. 10 will be described below, with reference to FIG. 12.

In step S41, the main CPU 41 determines the execution number of bonus game. As shown in FIG. 15, in a random number table to be used to determine the execution number of bonus game, a range of random numbers is associated to one execution number of bonus game. For example, when one of random numbers “0” to “199” is selected from among random numbers “0” to “255”, the main CPU 41 determines that the bonus game is executed one time. A probability in which the bonus game is executed one time is “200/256”. When one of random numbers “253” to “255” is selected from among random numbers “0” to “255”, the main CPU 41 determines that the bonus game is executed five times. A probability in which the bonus game is executed five times is “3/256”.

In step S42, the main CPU 41 sets a defined region group based on the rearrangement position (that is, defined region 28b2 or 28d2) of symbol “JOKER”. For example, when the symbol “JOKER” is rearranged on the defined region 28d2 shown in FIG. 1, the main CPU 41 sets the defined region group which is composed of the defined region 28d2 and the defined regions adjacent to the defined region 28d2.

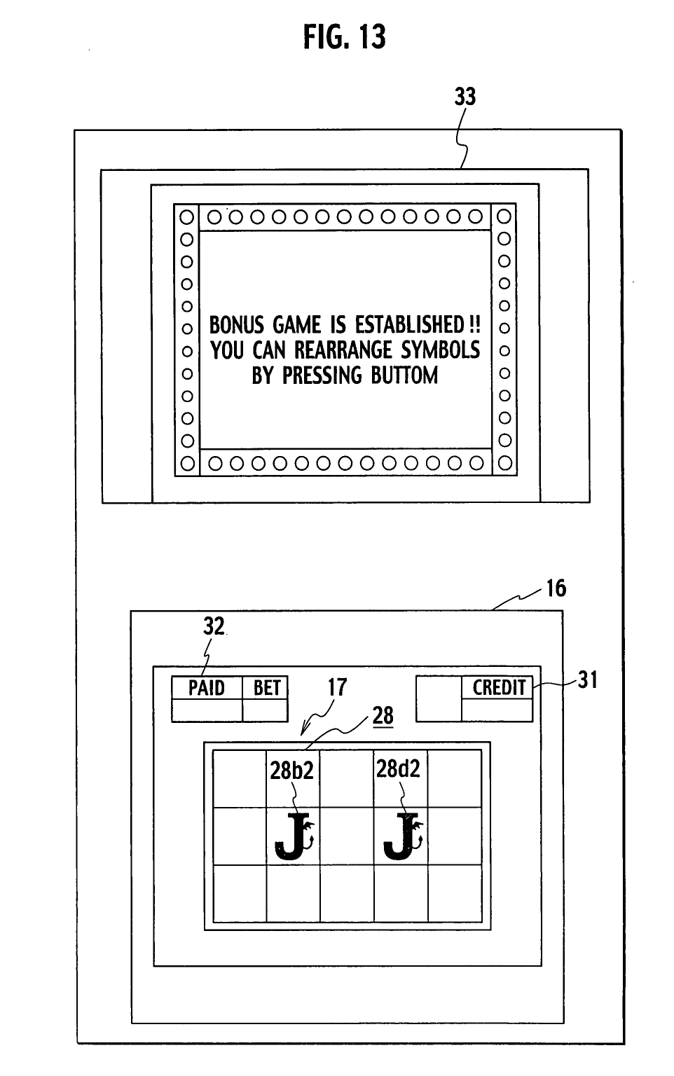

In step S43, the main CPU 41 notifies a player of the start of bonus game. More specifically, when a symbol “JOKER” is rearranged on the defined region 28d2 (or defined region 28b2) as shown in FIG. 13, the main CPU 41 displays a message “BONUS GAME IS ESTABLISHED!! YOU CAN REARRANGE SYMBOLS BY PRESSING BUTTON” on the upper liquid crystal display 33 to notify the player that he/she can execute the bonus game. Then, the main CPU 41 changes into a symbol “WILD JOKER” the symbol “JOKER” rearranged on the defined region 28d2, and displays a message “BONUS GAME STARTS!” on the upper liquid crystal display 33 and variably displays symbols on the defined region group which is composed of the defined region 28d2 and the defined regions adjacent to the defined region 28d2 (see FIG. 1).

In step S44, the main CPU 41 determines whether or not a spin button 23 is pressed. More specifically, the main CPU 41 determines whether or not it receives an input signal from the spin switch 23S. If the spin button 23 is not pressed, the process remains in the step S44.

If the spin button 23 is pressed, the main CPU 41 determines symbols to be rearranged on the defined region group based on the random number table for bonus game (step S45). More specifically, the main CPU 41 executes a symbol determination program stored in the RAM 43 to determine symbols to be rearranged (see FIG. 11).

In step S46, the main CPU 41 variably displays symbols on the defined region group (defined regions 28c1, 28c2, 28c3, 28d1, 28d2, 28d3, 28e1, 28e2, 28e3). Then, the main CPU 41 statically displays the symbols determines in the step S45 on the defined region group.

In step S47, the main CPU 41 determines whether or not a certain symbol combination which provides a payout is established on the defined region group. In the bonus game, the main CPU 41 determines the certain symbol combination based on the random number table for bonus game (see FIG. 6). If the certain symbol combination is not established, the process returns to step S44.

If the certain symbol combination is established, the main CPU 41 carries out a payout based on the payout table for bonus game (see FIG. 8, Step S48). In step S49, the main CPU 41 determines whether or not the execution number of bonus game has reached the execution number set in the step S41. If the execution number of bonus game has not reached the execution number set in the step S41, the main CPU 41 adds one to the execution number of bonus game and the process returns to step S43. If the execution number of bonus game has reached the execution number set in the step S41, the process is finished.

Next, the advantageous features of the slot machine 10 will be described below.

When a symbol “JOKER” is rearranged on the defined region 28b2 or 28d2 in the base game, the main CPU 41 sets a defined region group which is composed of the defined region 28b2 or 28d2 and the defined regions adjacent to the defined region 28b2 or 28d2, and executes the bonus game. Then, the main CPU 41 variably displays and rearranges symbols on the defined region group. Namely, the main CPU 41 executes the bonus game in which a probability of each payout is higher than one in the base game, on the certain defined region group by the certain number.

Therefore, the slot machine 10 allows a player to be interested in a game for a long time, in comparison with the conventional slot machine, because it can increase a player's expectation in the base game as to whether or not a symbol (e.g. the symbol “JOKER”) which functions as a bonus trigger is stopped on a certain defined region (e.g. the defined region 28b2 or 28d2), and increase a player's expectation in the bonus game as to whether or not a certain symbol combination which provides a payout is stopped on a certain defined region group which is composed of the certain defined region and defined regions adjacent to the certain defined region, under a condition where a probability of payout in the bonus game is higher than one in the base game. As a result, the slot machine 10 has the ability to pull in more customers.

It is noted that the main CPU 41 may display nothing or moving images (or still images) such as characters and/or messages related to a game effect, on defined regions other than the defined regions forming the defined region group.

Although the slot machine 10 is described according to the above exemplary embodiment, each configuration of the slot machine 10 may be replaced by an arbitrary configuration having the same functions.

What is claimed is:

1. A slot machine comprising:
a display that includes a plurality of defined regions in a matrix state which includes one or more rows and one or more columns and rearranges symbols arranged on defined regions; and
a controller operable to change the number of defined regions on which symbols are rearranged according to a game mode which includes a base game and a bonus game.

2. The slot machine according to claim 1, wherein the controller determines the number of executions of the bonus game every shifting the game mode from the base game to the bonus game.

3. The slot machine according to claim 1, wherein the controller sets a probability in which a symbol combination which provides a payout is rearranged on the defined regions in the base game is higher than one in which a symbol combination which provides a payout is rearranged on the defined regions in the bonus game.

4. A slot machine comprising:
a display that includes a plurality of defined regions in a matrix state which includes one or more rows and one or more columns and rearranges symbols arranged on defined regions; and
a controller operable to variably display symbols on the plurality of defined regions in a base game, shift a game mode from the base game to a bonus game when a certain symbol is statically displayed on a certain defined region in the base game, and variably and then statically display symbols on a defined region group which includes one or more defined regions in the bonus game.

5. The slot machine according to claim 4, wherein the controller determines the number of executions of the bonus game every shifting the game mode from the base game to the bonus game.

6. The slot machine according to claim 4, wherein the controller sets a probability in which a symbol combination which provides a payout is statically displayed on the plurality of defined regions in the base game is higher than one in which a symbol combination which provides a payout is statically displayed on the defined region group in the bonus game.

7. A slot machine comprising:
a display that includes a plurality of defined regions in a matrix state which includes one or more rows and one or more columns and rearranges symbols arranged on defined regions; and
a controller operable to variably display symbols on the plurality of defined regions in a base game, shift a game mode from the base game to a bonus game when a certain symbol is statically displayed on a certain defined region in the base game, and variably and then statically displayed symbols on a defined region group which includes the certain defined region and defined regions adjacent to the certain defined region in the bonus game.

8. The slot machine according to claim 7, wherein the controller determines the number of executions of the bonus game every shifting the game mode from the base game to the bonus game.

9. The slot machine according to claim 7, wherein the controller sets a probability in which a symbol combination which provides a payout is statically displayed on the plurality of defined regions in the base game is higher than one in which a symbol combination which provides a payout is statically displayed on the defined region group in the bonus game.

10. A playing method of a slot machine comprising the step of:
changing the number of defined regions on which symbols are rearranged according to a game mode which includes a base game and a bonus game,
wherein
symbols arranged on a plurality of defined regions in a matrix state which includes one or more rows and one or more columns are rearranged in the base game and
the game mode is shifted from the base game to a bonus game.

11. The playing method of the slot machine according to claim 10, further comprising the step of determining the number of executions of the bonus game every shifting the game mode from the base game to the bonus game.

12. The playing method of the slot machine according to claim 10, further comprising the step of setting a probability in which a symbol combination which provides a payout is rearranged on the plurality of defined regions in the base game is higher than one in which a symbol combination which provides a payout is rearranged on defined regions in the bonus game.

13. A playing method of a slot machine comprising the steps of:
executing a base game in which symbols arranged on a plurality of defined regions in a matrix state which includes one or more rows and one or more columns are rearranged;
shifting a game mode from the base game to a bonus game when a certain symbol is statically displayed on a certain defined region in the base game; and
executing the bonus game in which symbols are variably and then statically displayed on a defined region group which includes one or more defined regions.

14. The playing method of the slot machine according to claim 13, further comprising the step of determining the number of executions of the bonus game every shifting the game mode from the base game to the bonus game.

15. The playing method of the slot machine according to claim 13, further comprising the step of setting a probability in which a symbol combination which provides a payout is statically displayed on the plurality of defined regions in the base game is higher than one in which a symbol combination which provides a payout is statically displayed on the defined region group in the bonus game.

16. A playing method of a slot machine comprising the steps of:
executing a base game in which symbols arranged on a plurality of defined regions in a matrix state which includes one or more rows and one or more columns are rearranged;
shifting a game mode from the base game to a bonus game when a certain symbol is statically displayed on a certain defined region in the base game; and
executing the bonus game in which symbols are variably and then statically displayed on a defined region group which includes the certain defined region and defined regions adjacent to the certain defined region in the bonus game.

17. The playing method of the slot machine according to claim 16, further comprising the step of determining the number of executions of the bonus game every shifting the game mode from the base game to the bonus game.

18. The playing method of the slot machine according to claim 16, further comprising the step of setting a probability in which a symbol combination which provides a payout is statically displayed on the plurality of defined regions in the base game is higher than one in which a symbol combination which provides a payout is statically displayed on the defined region group in the bonus game.
